(19) United States
(12) Patent Application Publication
(10) Pub. No.: US 2023/0101662 A1
(43) Pub. Date: Mar. 30, 2023

(54) Ventilation unit for a refrigeration cabinet

(71) Applicant: Binder GmbH, Tuttlingen (DE)

(72) Inventors: Sebastian HUBER, Boettingen (DE); Alexander PEPLER, Donaueschingen (DE)

(73) Assignee: Binder GmbH, Tuttlingen (DE)

(21) Appl. No.: 17/952,812

(22) Filed: Sep. 26, 2022

(30) Foreign Application Priority Data
Sep. 27, 2021 (DE) 10 2021 124 960.0

(51) Int. Cl. F25D 17/08

(52) U.S. Cl. CPC F25D 17/08

(57) ABSTRACT

A ventilation unit for a low temperature chamber with a tube-shaped base body, having a heating element, an inlet side end with an inlet opening and an outlet side end with an outlet opening, wherein the base body has a tapered form such that the inlet opening has a greater area than the outlet opening. The inlet opening can be located in a first front side plane and the outlet opening can be located in a second front side plane, wherein the first front side plane and the second front side plane are substantially parallel offset with respect to one another, and wherein at perpendicular projection of the first front side plane onto the second front side plane, the inlet opening and the outlet opening are disposed offset with respect to one another. The base body can have a mechanical valve configured to open under pressure induction.

### CROSS REFERENCE TO RELATED APPLICATIONS

This application claims priority to German Patent Application No. 10 2021 124 960.0, filed Sep. 27, 2021, the entirety of which is incorporated by reference.

### BACKGROUND

The present application relates to a ventilation unit for a low temperature chamber.

### SUMMARY

A known problem in low temperature chambers such as refrigerators, freezers and, in particular, ultra low freezers whose interior volume can reach temperatures of approximately −90° C., is the fact that, when the door of the low temperature chamber is opened, an exchange of air takes place and warm air flows into the interior volume. After the door is subsequently closed again the air in the interior volume cools down markedly and thereby contracts such that an underpressure is generated. This underpressure must be compensated since, starting at a certain underpressure, the door of the low temperature chamber cannot be opened or the low temperature chamber can be damaged when it is opened.

Known is a ventilation unit for a low temperature chamber comprising heated piping of, for example, special steel in the interior of which a wire mesh is disposed. The piping is installed horizontally into the door or a side wall of the low temperature chamber. Opening the door activates the heating and de-ices the potentially frozen-up piping such that air flows through the piping and the pressure difference can be compensated. For this purpose, approximately 30 seconds are required before the door can be opened again.

The present disclosure addresses the problem of providing a ventilation unit for a low temperature chamber by which the required length of time after opening the door to a further opening of the door is as short as feasible and opening the door again immediately after a preceding opening is preferably enabled.

According to the present disclosure the problem is resolved through a ventilation unit for a low temperature chamber having the features and structures recited herein.

The ventilation unit according to the present disclosure for a low temperature chamber comprises a tube-shaped base body, wherein the base body comprises a heating element and wherein the base body comprises an inlet side end with an inlet opening and an outlet side end with an outlet opening, wherein the base body is implemented in tapered form such that the inlet opening has a larger area than the outlet opening, wherein the inlet opening is disposed in a first front side plane and the outlet opening is disposed in a second front side plane, wherein the first front side plane and the second front side plane are disposed substantially parallel offset with respect to one another, and wherein, at a perpendicular projection of the first front side plane onto the second front side plane, the inlet opening and the outlet opening are disposed offset with respect to one another, and wherein in the base body a mechanical valve is disposed which is implemented such that, when a specified pressure difference between the inlet side end and the outlet side end is exceeded with an underpressure at the outlet side end, it opens under pressure induction however prevents an air flow from the outlet side end to the inlet side end.

As offset disposition of inlet opening and outlet opening is to be understood a configuration in which the intersection of sets of inlet opening and outlet opening in the projection is less than the outlet opening. In particular the inlet opening and the outlet opening are not disposed concentrically. Thereby that at a perpendicular projection of the first front side plane onto the second front side plane the inlet opening and the outlet opening are disposed offset with respect to one another results an inclination of the base body in the installed state. The installation is in particular carried out such that the outlet opening, which, in particular, forms the cold side of the ventilation configuration, is located lower than the inlet opening. Due to the height offset a stable air layering can be established in the base body which can lead to the valve remaining frost-free even if the heating element is not permanently switched on. This enables the pressure compensation even shortly after the opening of the door.

Thereby that the base body tapers toward the outlet opening the flow rate of the mass flow increases toward the outlet opening which can entrain potentially forming condensation water whereby the risk of ice formation within the base body can be decreased.

The mechanical valve has the advantage that it does not require additional power supply and responds exclusively to the pressure difference.

An advantageous further development provides that at a perpendicular projection of the first front side plane onto the second front side plane the inlet opening and the outlet opening are disposed offset with respect to one another such that the inlet opening and the outlet opening do not overlap. In the condition of installation this means in particular that the height offset between the inlet opening and the outlet opening is of such magnitude that it is not possible to look through them horizontally. Such disposition can facilitate the development of a stable air layering.

The valve preferably comprises a valve seat and a valve body, wherein the valve body is implemented in disk shape. Such a valve can be developed so as to be especially compact.

The disk-shaped valve body is advantageously disposed such that it is inclined against the first front side plane. The air stream can thereby flow especially advantageously against the valve body.

According to an advantageous further development of the present disclosure the base body has a longitudinal axis and the disk-shaped valve body is disposed substantially perpendicularly to the longitudinal axis. Such disposition enables the uniform loading of the valve body by the obtaining pressure difference.

A preferred further development of the present disclosure provides for the valve body to be supported under prestress in a closed position. This enables the simple and compact structure of the valve.

It is especially preferred for the valve body to be implemented as an umbrella valve. Sufficient responsiveness of the ventilation unit can thereby be achieved.

The valve body is advantageously fabricated of silicone.

The valve body preferably comprises a rotational axis which is oriented substantially parallel to the direction of air flow through the base body. Thereby uniform loading of the valve body can be achieved.

According to an especially preferred embodiment of the present disclosure two valves are disposed in the base body. The responsiveness of the ventilation unit can thereby be increased and the volume flow can be enlarged.

A preferred embodiment of the present disclosure provides for the rotational axes of the valve bodies of the two valves not to be oriented parallel to one another wherein preferably the angle between the two rotational axes is between 15° and 35°. The two valve bodies can thereby be disposed in each instance in the tapering tube such that each of the valve bodies is substantially disposed with its rotational axis oriented parallel to the air flow.

The heating element is preferably disposed on the outer side of the base body which can simplify the production of the ventilation unit.

According to a preferred embodiment of the present disclosure the outer side of the base body comprises structures, in particular grooves and/or projections, for fixing the position of the heating element. The heating element can thereby be fixed in position in simple manner.

The base body is preferably fabricated of a synthetic material, in particular of a thermoplastic synthetic material, especially preferably of polypropylene, preferably using an injection molding process which enables its simple and cost-effective fabrication.

An especially preferred embodiment of the present disclosure provides for the heating element to be implemented as a heating filament. The production can thereby be further simplified in that the heating filament is merely disposed on the outer side of the base body fabricated of synthetic material.

The base body advantageously encompasses two half-shells. Such implementation can especially simply be fabricated using an injection molding process and can simplify the assembly.

A low temperature chamber according to the present disclosure, especially a refrigerator, a freezer or an ultra low freezer comprises a ventilation unit as described above.

The ventilation unit is preferably installed in a wall of the low temperature chamber such that the inlet opening is directed toward the outer side, which means toward the warm side, and the outlet opening is directed toward the inner side, which means toward the cold side, of the low temperature chamber, wherein the outlet opening is disposed further down in the vertical direction than the inlet opening. It is especially preferred for the outlet opening to be disposed vertically below the inlet opening.

### BRIEF DESCRIPTION OF DRAWINGS

An embodiment example of the present application will be explained in detail in conjunction with the following Figures. Therein depict:

FIG. 1 a perspective view of an embodiment example of a ventilation unit according to the present application for a low temperature chamber,

FIG. 2 a lateral view of the ventilation unit according to FIG. 1,

FIG. 3 a top view onto the ventilation unit according to FIG. 1,

FIG. 4 a front view of the ventilation unit according to FIG. 1,

FIG. 5 a longitudinal section in lateral view through the ventilation unit according to FIG. 1,

FIG. 6 a longitudinal section in top view through the ventilation unit according to FIG. 1,

FIG. 7 the longitudinal section according to FIG. 5 with plotted longitudinal axes of the base body and in the cross section of a wall of a low temperature chamber,

FIG. 8 the longitudinal section according to FIG. 5 with plotted projection direction,

FIG. 9 the longitudinal section according to FIG. 6 with plotted direction of flow,

FIG. 10 a perspective view of the ventilation unit according to FIG. 1 with the upper half-shell of the base body omitted,

FIG. 11 a cutaway enlargement of FIG. 10 and

FIG. 12 a cutaway of a further perspective view of the ventilation unit according to FIG. 10.

FIG. 13 a low temperature chamber,

### DETAILED DESCRIPTION

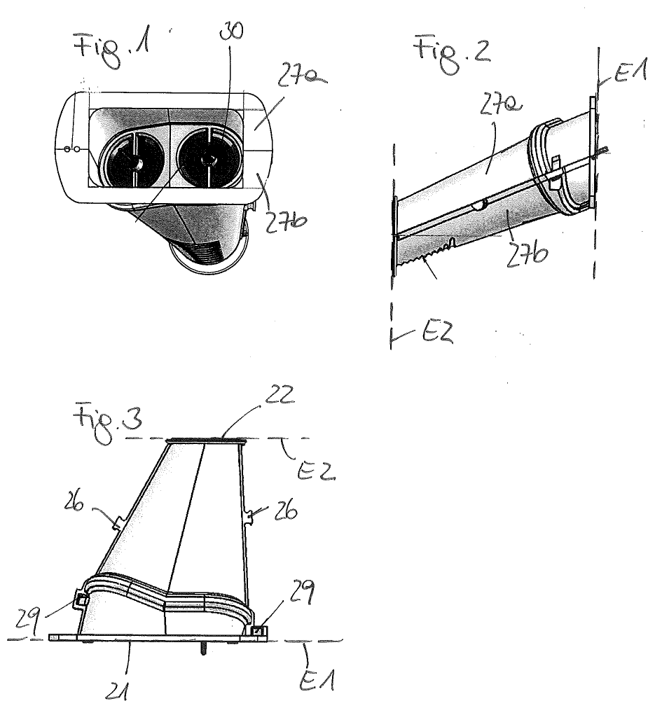

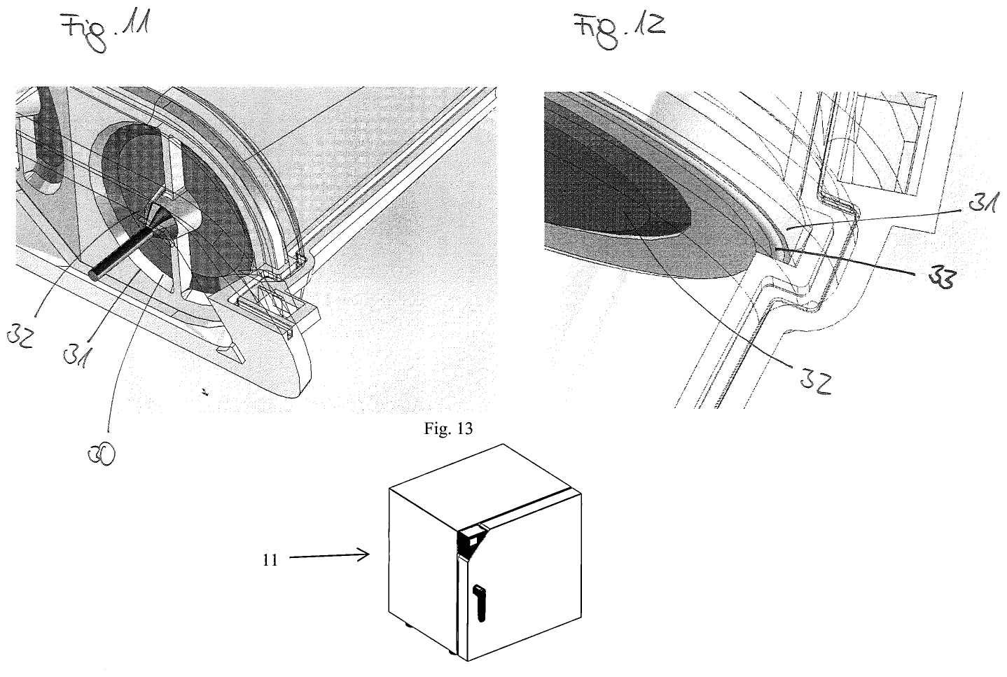

FIGS. 1 to 13 show different views of a ventilation unit 10 according to the present disclosure for a low temperature chamber 11 wherein, for clearer overview, not all reference symbols are shown in all Figures.

The ventilation unit 10 comprises a tube-shaped base body 20 with an inner side 24, an outer side 23, an inlet side end 20a and an outlet side end 20b, wherein at the inlet side end 20a an inlet opening 21 is disposed and at the outlet side end 20b an outlet opening 22 is disposed. The inlet opening 21 is disposed in a first front side plane E1 and the outlet opening 22 is disposed in a second front side plane E2, wherein the first front side plane E1 and the second front side plane E2 are substantially disposed offset in parallel with respect to one another (cf. especially FIG. 5).

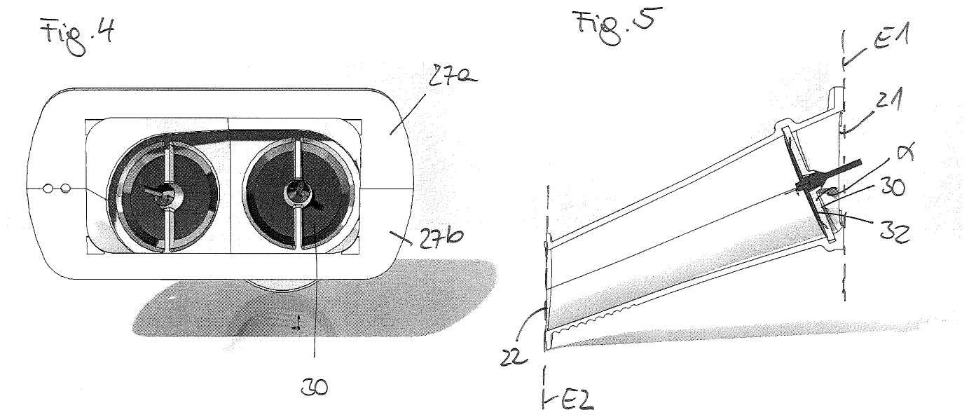

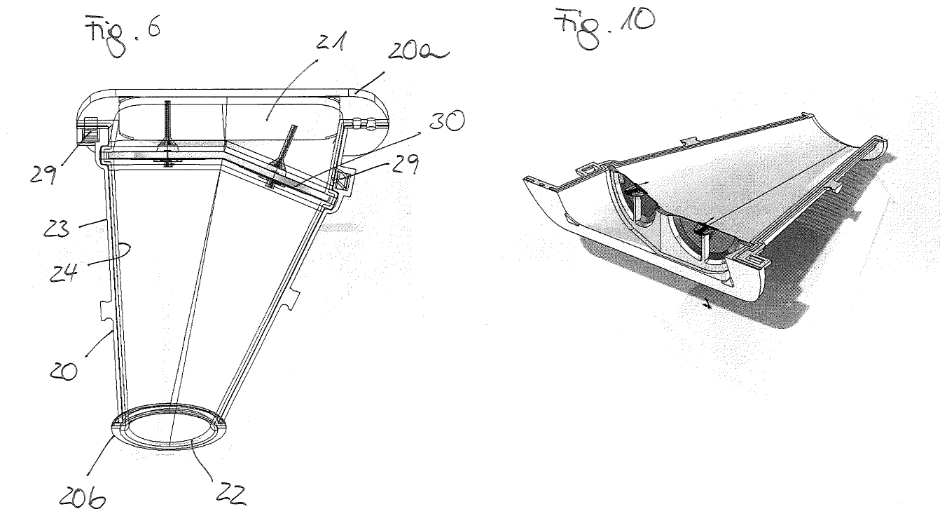

The base body 20 is implemented in tapered form such that the inlet opening 21 has a larger area than the outlet opening 22 (cf. in particular FIGS. 3 and 6).

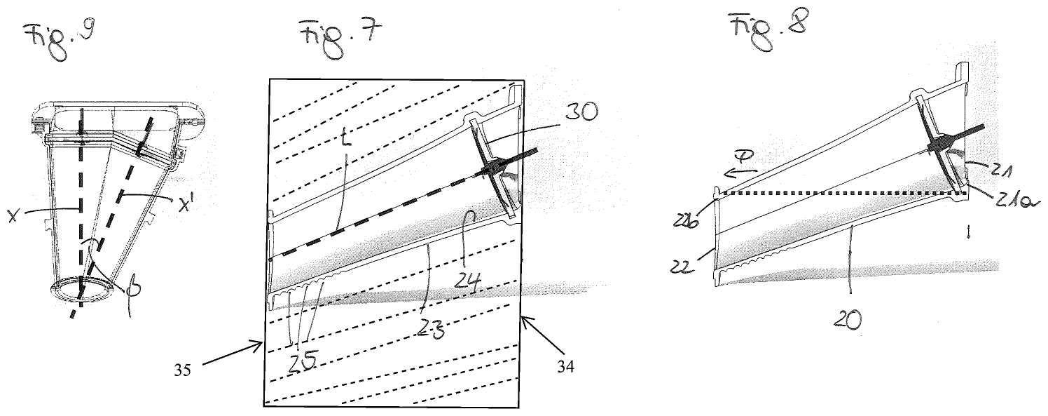

At a perpendicular projection of the first front side plane E1 onto the second front side plane E2 which, as depicted as plotted in FIG. 8, can take place parallel to the projection direction P, the inlet opening 21 and the outlet opening 22 are disposed offset with respect to one another. Stated differently, the inlet opening 21 in the projection overlaps the outlet opening 22 at most sectionwise. The inlet opening 21 and the outlet opening 22 do not, as is especially preferred, have an intersection in the projection or otherwise do not overlap. This embodiment is illustrated in FIG. 8 thereby that the lower edge 21a of the inlet opening 21 is disposed above the upper edge 22b of the outlet opening 22 such that in the projection no overlap of the inlet opening and the outlet opening is formed.

The base body 20 can be fabricated of a synthetic material, in particular of a thermoplastic synthetic material, especially preferably of polypropylene. The base body 20 is preferably fabricated using an injection molding process. The base body 20 can be fabricated of two half-shells 27a, 27b as is discernible for example in FIGS. 1 and 4. The two half-shells 27a, 27b can be joined after their separate fabrication to form the base body 20. They can, for example, be fixed relative to one another by means of a snap connection 29, especially preferably by means of two snap connections 29. The snap connections 29 are herein preferably disposed in the region of the inlet side end 20a.

The base body 20 comprises a heating element which is preferably implemented as a heating filament. The heating element can be disposed in simple manner on the outer side 23, for example by being wound multiple times around the base body 20. To achieve fixing its position the heating element can be emplaced in the grooves 25 disposed on the outer side 23 (cf. FIG. 7). Alternatively, or additionally, projections 26 can be disposed on the outer side 23 (cf. FIG. 3) at which the winding direction of the heating element can be changed, or the heating element can be clamped in order for it to be better retained and be prevented from sliding off. If the base body 20 is composed of two half-shells 27a, 27b, wrapping the two half-shells 27a, 27b with the heating element can fix the two half-shells 27a, 27b relative to one another. In the base body 20 is disposed at least one mechanical valve 30 which is implemented such that when a specified pressure difference between the inlet side end 21 and the outlet side end 22 is exceeded with an underpressure at the outlet side end 22, it opens under pressure induction. The valve 30 is also configured to prevent an air stream from the outlet side end 22 to the inlet side end 21. An underpressure at the outlet side end 22 can be compensated thereby that the valve 30 opens and air flows through the base body 20 from the inlet side end 21 through the valve 30 to the outlet side end 22.

The valve 30 can comprise a valve seat 31 and a valve body 32, wherein the valve body 32 is implemented in disk form. The valve body 32 is in particular implemented as an umbrella valve. The valve body 32 can be fabricated of silicone. A seal 33 can be disposed peripherally on the valve seat 31 (cf. FIG. 12). The valve 30 is herein in particular disposed closer to the inlet side end 21 than to the outlet side end 22 of the base body 20.

As is in particular discernable in FIG. 5 the disk-shaped valve body 32 can be disposed such that it is inclined against the first front side plane E1, The angle of inclination α can be in the range of 20° to 40°, for example, approximately 30° (cf. FIG. 5). The base body 20 can have a longitudinal axis L and the disk-shaped valve body 32 can be disposed substantially perpendicularly with respect to the longitudinal axis L (cf. FIG. 7). After installation of the ventilation unit 10 in a low temperature chamber such that the inlet opening 21 is substantially disposed vertically in an outer wall 34 of the low temperature chamber and the outlet opening is substantially disposed horizontally in an inner wall 35 of the low temperature chamber, the angle of inclination α corresponds approximately to the inclination of the tube-shaped base body 20 against the horizontal.

The valve body 32, implemented in particular as an umbrella valve, can, in particular, be mounted so as to be supported under prestress in a closed position. If the force acting through a pressure difference between the inlet side end 21 and the outlet side end 22 onto the valve body 32 is greater than the closing force of the umbrella valve, the valve body 32 under pressure induction is changed from the closed position into an open position in which air can flow through the valve 30 and a pressure compensation is effected. As soon as the differential pressure becomes less or pressure compensation has even been established, the force acting onto the valve body 32 is lower than the closing force of the umbrella valve such that the valve 30 closes again.

The valve body 32 can have a rotational axis R which is oriented substantially parallel to the direction of the air flow through the base body 20. The direction of air flow x can correspond to the longitudinal axis L.

The ventilation unit 10 can comprise more than one valve 30. In the depicted embodiment example, the ventilation unit 10 comprises two valves 30, 30′. The further valve 30′ is in particular implemented like the valve 30. The valve 30′ has a rotational axis R′.

The rotational axes R, R′ of the two valve bodies 32 of the two valves 30, 30′ are preferably not oriented parallel to one another but rather intersect at an angle (3, preferably in the region of the outlet opening 22 (cf. FIG. 9), wherein the angle β between the two rotational axes R, R′ is preferably between 15° and 35°. Due to the tapering physical form of the base body 20 the flow velocity of the air flow increases toward the outlet side end 22. Through the disposition of the rotational axes R, R′ of the two valve bodies 32 at an angle with respect to one another an advantageous incident flow and pressure application of both valve bodies 32 can be achieved similarly. It can herein be achieved that both valve bodies 32 of the two valves 30, 30′ are each oriented substantially perpendicularly to the direction of air flow x, x′ through them (cf. FIG. 9).

The ventilation unit 10 is applied in particular in a low temperature chamber, for example a refrigerator, a freezer or an ultra low freezer. The ventilation unit 10 can herein be installed in a wall of the low temperature chamber such that the inlet opening 21 of the low temperature chamber is directed toward the outer side 23, which means toward the warm side, and the outlet opening 22 toward the inner side 24, which means toward the cold side, wherein the outlet opening 22 is disposed further down in the vertical direction than the inlet opening 21 (cf. FIG. 5). The outlet opening 22 is especially preferably disposed vertically below the inlet opening 21.

### LIST OF REFERENCE SYMBOLS

10 Ventilation unit

11 low temperature chamber

20 Base body

20a l Inlet side end

20b l Outlet side end

21 Inlet opening

22 Outlet opening

23 Outer side

24 Inner side

25 Groove

26 Projection

27a Half shell

27b Half shell

29 Snap connection

30 Valve

30′ Valve

31 Valve seat

32 Valve body

33 Seal

E1 First front side plane

E2 Second front side plane

P Projection direction

R Rotational axis

R′ Rotational axis

αAngle of inclination

βAngle

L Longitudinal axis

x Direction of air flow

x′ Direction of air flow

What is claimed:

1. A ventilation unit for a low temperature chamber, comprising:
a tube-shaped base body comprising a heating element, an inlet side end with an inlet opening and an outlet side end with an outlet opening, wherein the base body has a tapered form such that the inlet opening has a greater area than the outlet opening,
wherein the inlet opening is disposed in a first front side plane and the outlet opening is disposed in a second front side plane,
wherein the first front side plane and the second front side plane are disposed substantially parallel offset with respect to one another, and
wherein at a perpendicular projection of the first front side plane onto the second front side plane, the inlet opening and the outlet opening are disposed offset with respect to one another, and
wherein the base body has a mechanical valve which configured such that when a specified pressure difference between the inlet side end and the outlet side end is exceeded with an underpressure at the outlet side end, the valve opens under pressure induction while preventing an air stream from the outlet side end to the inlet side end.

2. The ventilation unit as in claim 1, wherein in a perpendicular projection of the first front side plane onto the second front side plane, the inlet opening and the outlet opening are disposed offset with respect to one another such that no overlap of the inlet opening and the outlet opening is formed.

3. The ventilation unit as in claim 1, wherein the valve comprises a valve seat and a disk-shaped valve body.

4. The ventilation unit as in claim 3, wherein the disk-shaped valve body is disposed at an inclination toward the first front side plane.

5. The ventilation unit as in claim 4, wherein the base body comprises a longitudinal axis and the disk-shaped valve body is disposed substantially perpendicularly to the longitudinal axis.

6. The ventilation unit as in claim 3, wherein the disk-shaped valve body is mounted so as to be supported under pre-stress in a closed position.

7. The ventilation unit as in claim 3, wherein the disk-shaped valve body is an umbrella valve.

8. The ventilation unit as in claim 3, wherein the disk-shaped valve body is fabricated of silicone.

9. The ventilation unit as in claim 3, wherein the disk-shaped valve body comprises a rotational axis oriented substantially parallel to a direction of air flow through the base body.

10. The ventilation unit as in claim 3, wherein the base body comprises a second disk-shaped valve body.

11. The ventilation unit as in claim 10, wherein rotational axes of the disk-shaped valve body and the second disk-shaped valve body have rotational axes with an angle with respect to each other of between 15° and 35°.

12. The ventilation unit as in claim 1, wherein the base body further comprises an outer side and a heating element disposed thereon.

13. The ventilation unit as in claim 12, wherein the outer side of the base body comprises grooves and/or projections to which the heating element is fixed.

14. The ventilation unit as in claim 13, wherein the heating element is a heating filament.

15. The ventilation unit as in claim 1, wherein the base body is fabricated of a thermoplastic synthetic material by an injection molding process.

16. The ventilation unit as in claim 1, wherein the base body comprises two half-shells.

17. The ventilation unit as in claim 1, further comprising a low temperature chamber.

18. The ventilation unit as in claim 17, wherein the ventilation unit is installed in a wall of the low temperature chamber such that the inlet opening is directed toward the outer side and the outlet opening is directed toward the inner side of the low temperature chamber, wherein the outlet opening is disposed further down in the vertical direction than the inlet opening.
